(19) United States
(12) Patent Application Publication
(10) Pub. No.: US 2004/0081553 A1
(43) Pub. Date: Apr. 29, 2004

(54) Versatile axial fan and centrifugal shutter mechanism

(76) Inventor: Angelo Milana, Laval (CA)

Correspondence Address: ANGELO MILANA, 1700 BOUL LEVEQUE EAST APT.#3, LAVAL, H7G-451, CA

(21) Appl. No.: 10/679,475

(22) Filed: Oct. 7, 2003

(30) Foreign Application Priority Data
Oct. 29, 2002 (CA) 2,405,088

(51) Int. Cl. F03B 11/08

(52) U.S. Cl. 415/121.2

(57) ABSTRACT

An efficient axial fan has housing with a square inlet opening and a round outlet opening, a fan assembly with a drive motor and a propeller coupled thereto. The entrance of the housing is provided with a shutter assembly disposed horizontally or vertically across the entrance of the fan and comprising a plurality of vanes including a central operative vane operated by a centrifugal shutter mechanism secured to one end of the propeller shaft, opposite to the propeller and adjacent to the operative central vane of the shutter assembly. The centrifugal shutter mechanism is normally provided with a hermetic housing comprising a pair of radial masses operatively connected by means of a pair of pivoting arms to an axial sliding reciprocating actuator which is disposed adjacent to the shutter central operative vane. When the fan is on, the radial masses by centrifugal action rotate the pair of arms which push the axial sliding reciprocating actuator away from the central operative vane allowing an extension spring associated with the shutter assembly to cause the opening of the shutter. When the fan is off, an internal compression spring housed within the axial sliding actuator pushes it against the central operative vane causing the closing of the shutter. The propeller comprises a plurality of radially disposed blades which are entirely surrounded by a Venturi and are provided with means for adjusting the tip blade clearance with the Venturi.

### BACKGROUND OF THE INVENTION

1. Field of the Invention

This invention pertains generally to an energy efficient axial fan for exhausting humid, corrosive and dusty air from a variety of buildings, including by way of example: foundries, manufacturing facilities, poultry operations, green houses, etc.

In particular the present invention relates generally to new and useful improvements of an axial fan comprising a shutter operated by a centrifugal mechanism.

2. Description of the Prior Art

Most axial fans are provided with gravity shutters which, are closed by gravity and opened by the air flow exiting of the fan. When said fans operate in dusty atmospheres, if air velocity is lower than the minimum velocity to prevent dust settling, said dust quickly accumulates on them, increasing the overall weight of the shutters. The heavier the shutters are, the harder it is for the fan to blow air through them, so that the fan moves less air and efficiency is lessened. Therefore, gravity shutters need routine cleaning but, after cleaning them, just after few days of operation, they once again are covered with dust and one can clearly see them hanging at an angle, partially closed again. During the cleaning operation it is possible to damage them, resulting in shutters that will not close or open completely.

Cleaning the shutters is a tough task and therefore, they are not cleaned as often as they should. Dust built up creates undesirable flow restrictions, which reduce the air flow capacity of the fan and affects the opening and closing of the shutters; as a result it causes undesirable air infiltration and building heat losses.

The air moving capacity of a fan with gravity shutters is also negatively affected by stormy weather. If a strong breeze hits the operating fan the shutters partially close. The wind lets up and the shutters open again. When the fan is off, high winds can open said shutters admitting unexpected cold air or warm air into the building or allowing the inside air to escape therefrom.

When the fan with gravity shutters is operating there is a “constant battle” between the air flow, to blow the shutters open and the gravity forces trying to close them, this translates to a continuous oscillation of the shutters, pressure losses, waste of energy, vibrations, wear and reduction of the air flow.

Enhancing State-of-the-art, in air moving axial fans mainly focuses in three directions. First, the ability to smoothly transition the air from the intake opening of the fan housing into the inlet side of the Venturi and the propeller. Second, the ability to decrease the gap between said Venturi and the propeller. Third, the ability to provide the propeller and other elements exposed to air flow with airfoil shaped surfaces. Airfoil shaped blades assure quietest and most efficient operation of the fan.

In conventional axial fans, due to the limited capabilities of the prior techniques in manufacturing and producing with precision fan housings and Venturi, the performance of the fans has been limited. Designers were obliged to leave a relatively large tip blade clearance for accommodate imperfection of manufacturing and thermal variations and expansions of the propeller blades and or the Venturi for preventing, in same situations, the fan blades to come into contact with said Venturi. Many studies show that the larger is this space the lower is the fan efficiency.

To solve the problems of said gravity shutters it had been used motorized shutters or centrifugal shutter systems. The motorized shutters are relatively too expensive; therefore the art has developed various centrifugal systems for operate said shutters, for fully open and keep them positively open, in spite of the inevitable dust accumulation thereon and in spite of stormy weather.

The use of said centrifugal systems enhance the fan performance because said devices wide open the shutters and because the air pressure losses of said conventional gravity shutters, caused by the out-flowing air required to keep said shutters opened, are eliminated. Air is allowed to flow unobstructed at the maximum pressure through the positively wide open shutters.

Using a centrifugal device translates to significantly reduce the workload of the drive electric motor, and this allows a reduction or reallocation of this power surplus.

A thorough description of the prior art known to the Applicant which is pertinent to the present application is described in the following patents:

| INVENTOR | U.S. Pat. No. | DATA GRANTED |
|---|---|---|
| Mancinelli | 4,217,816 | Aug. 1980 |
| Gigola | 5,195,928 | Mar. 1993 |
| Mancinelli | 5,288,202 | Feb. 1994 |
| Milana | 6,276,895 | Aug. 2001 |

In the known art, better described in U.S. Pat. No. 6,276,895 by the same Applicant, the problem of vibrations and rattling were solved, but dust accumulation and air leakage from the shutters were not.

The fans with centrifugal devices of the prior art comprise an electric motor, a propeller and a shutter assembly comprising a plurality of horizontal extending vanes including a central operative vane, disposed horizontally in proximity of the propeller. The centrifugal devices of Mancinelli comprise two centrifugal masses and the one of Gigola comprises tree masses rotating with the fan. As soon the drive motor of said fans starts, the propeller speeds up therefore, the rotating masses move outwardly radially from the fan axis, due to centrifugal action. Through a series of complex linkages the movement of the masses forces the shutter wide open even in stormy weather. As the fan shuts off, the centrifugal masses gradually move back towards the fan axis and the shutter assisted by springs close.

While having these and other advantages the fans of Mancinelli and Gigola have some disadvantage. For example they need routine maintenance for maintaining the centrifugal mechanism and their horizontal disposed shutters clean, said shutters are disposed at the exhaust where air velocity is relatively higher than at the intake of said fans, so the pressure losses are greater and efficiency of said fans is lessened.

In addition, the above devices comprise an axially sliding actuator rotatably connected with the shutter central vane for transmitting trough complex linkages the centrifugal forces of said masses; therefore the actuators transmit to said shutter the vibrations of the propeller, as well as the vibrations of the centrifugal mechanisms. Moreover, when said fans are in operation said mechanisms push continuously via a thrust bearing the shutter therefore they are subject to continuous friction, oscillations and wear.

None of the known fans of the prior art solves the problems of dust settling on their horizontally disposed blades or vanes and none of said fans has the unique feature of the fan of the present invention.

There remains the need for a fan with a self-cleaning shutter suitable to prevent the usual dust accumulation on the shutters of the fan of the prior art. The Applicant in effect finds that if a fan has to work in very dusty atmospheres, to overcome the problem of dust settling on the shutters; it is convenient to design the shutter with vertically extending blades, so to have an automatic cleaning effect which prevents dust to accumulate thereon. However, a vertical shutter must be operated by a device, for example a centrifugal mechanism.

Various studies from many Universities for poultry house buildings shows that dust accumulation on conventional shutters of the fans of the prior art cause a reduction of the air flow by 30%. If said fans move 30% less air than they should, more fans are necessary to do the work, as a result there are higher electricity bills and increased wear on the fan.

The farm buildings usually require a large number of fans which during hot weather operate continuously 24 hours a day therefore requires a significant energy use. Thus, it is important to have a high efficiency fan to conserve electrical energy over the long period that the fan is operated.

There is a need and a demand for a high energy efficient practically maintenance free fan, with the unique features described hereinafter.

### SUMMARY OF THE INVENTION

The longstanding but heretofore unfulfilled need for high efficiency fan to move efficiently large volume of humid, corrosive and dusty atmospheres with a minimum of maintenance is now fulfilled by the invention disclosed hereinafter and summarized as follows.

The present invention provides an energy efficient axial fan comprising a housing mounted externally through a building wall at a downwardly slanted angle thereto.

As example the Applicant shows an axial fan with a stationary streamlined housing enclosure with a square inlet opening with a shutter assembly comprising a plurality of vanes including a central operative vane interconnected with crank rods and at least one tie rod, so to move at unison smoothly and noiseless from a first closed position, to a second open position to close or open said inlet opening. The shutter assembly further comprises a shutter frame on which are mounted said vanes and an extension operative spring, interposed between said shutter frame and said tie rod provided for causing the opening of the shutter upon fan rotation.

The fan housing enclosure further comprises an axially spaced second opening of round cross section, a streamlined central structural member axially spaced between said openings, connecting two opposite sides of the housing enclosure and comprising a pair of airfoil wings, a drive motor and a pair of rigid pillow blocks bearings supporting the fan shaft, which in turn supports a propeller-pulley assembly coupled with a belt to the drive motor and comprising a plurality of radial blades pivotally received and bolted to the pulley hub, said blades further comprising means for minimizing tip blades and Venturi clearance.

An important feature of the present invention is the introduction of a centrifugal shutter mechanism mounted upon the propeller shaft, comprising means for locking said shutter in closed position, when the fan is not in operation and comprising means for allowing the shutters to open as soon as the fan starts to run. It is simple in design, compact, and it has a minimum number of parts and joints for preventing excessive looseness of the mechanism even after long-term use. It is suitable for pulling or pushing an element to be actuated, therefore is suitable for many others numberless applications.

In dusty environments, the dust or other foreign matter is able to collect to the fan shutters causing the aforementioned problems on the shutters and eventually jamming also the centrifugal shutter mechanism.

The problem associated with the conventional typical horizontally extending shutters of the axial fans of the prior art may be substantially overcome by providing a fan with a slanted housing having a shutter assembly comprising a plurality of vertically extending shutters operated by a centrifugal shutter mechanism. It is evident that dust present in the air passing through a vertically mounted shutter will tend mainly to settle on the bottom of the fan housing thus, it will not settle on the vertical surfaces of the vertically extending shutters, thereby a fan formed in accordance with the present invention has the noticeable advantage of having self-cleaning shutters or vanes which, contrary to the shutters of the prior art will not need frequent maintenance.

In addition, for preventing dust accumulation on the centrifugal shutter mechanism the Applicant provides a hermetic housing for enclosing the vital components of the centrifugal mechanism.

However, vertically mounted shutters opened by air and or by a spring or by a centrifugal device or other means, need a device for closing them, for example the Applicant provides a centrifugal shutter mechanism which comprises a pair of radial masses equally spaced apart in respect to the fan axis of rotation, located inside said hermetic housing, operatively connected via a pair of pivotal arms to an axial sliding reciprocating actuator comprising an internal compression spring, located coaxial to the fan axis of rotation adjacent to the shutter central operative vane.

Said axial actuator has in particular one operational end including means adapted for frictionally engaging and rotating the central operative vane of said shutter, from one first opened position to a second closed position and vice versa to open or to close said inlet opening of said axial fan.

When the fan is rotated for example, by an electric or hydraulic motor, said pair of masses move radially by centrifugal action and pushes, via the pair of rotating arms, the axial reciprocating actuator inward the closed housing, against the urge of the internal compression spring therefore, said axial sliding reciprocating actuator gradually frees said central operative vane of said shutter, allowing the aforesaid extension spring of said shutter frame, as the propeller reached the minimum designed speed to rotate quietly, quickly and smoothly all vanes in an open position.

This fan is particularly suitable to operate efficiently at variable speed and in very dusty atmospheres, its shutters vanes are designed to wide open when the propeller reach the speed of about 250 RPM, at this low speed the power requirements are relatively low and the cost to operate the fan is reduced. In hot weather the fan in a farm building usually runs 24 hours a day, seven days a week, the saving of electricity adds up and the energy saving become noticeable.

When the fan is stopped the centrifugal forces progressively decrease, therefore the internal compression spring of said reciprocating axial actuator pushes it out toward said central operative vane which is gradually forced to rotate around its longitudinal axis, for assuming a closed position and in the same time said tie rod will rotate all the others vanes in a closed position.

The centrifugal mechanism can operate for either direction of rotation and therefore the fan can be used in other applications for moving air in exhaust or intake mode.

The operating characteristic and the simplicity of design of the centrifugal mechanism of this invention gives many advantages over existing centrifugal devices thus, make it applicable to many different uses, such closing electric components and switches, valves, and alike.

In the other hand, it will be recognized by those skilled in the art that for some of said applications, it may be desirable to have the centrifugal mechanism adapted to pull or push the element to be operated. In this case the centrifugal mechanism of the present invention can be easily modified and the axial sliding actuator has to be rotatably coupled with the element to be actuated, to apply a pulling or pushing force. In said case the axial sliding reciprocating actuator operative end must be equipped with a thrust bearing. This reverse action is to be considered part of the present invention.

### OBJECT OF THE INVENTION

It is a primary object of the present invention generally to teach certain additional useful improvements upon the “Fan with centrifugal shutter mechanism” taught in my U.S. Pat. No. 6,276,895 granted August 2001.

A very important object of the present invention is to solve the problems concerning dust settling on fan shutters and leakage of air therefrom.

Another very important object of the present invention is to provide a propeller with means for adjusting the minimum tip blade clearance with the Venturi.

Another important object of the present invention is to reduce the cost of the axial fan; this objective is possible with a simplification, reduction of the number of parts and joints and increase performance of the fan.

Another object of the present invention is to provide a shutter assembly mounted either horizontally like the ones of the prior art or preferably vertically for handling very dusty air for preventing dust built up thereto.

A further object of the invention is to provide a safe centrifugal mechanism, simple in construction, positive in operation, designed to function for long periods of time and in a very large range of speeds without frequent servicing and repairs and adapted to work for pushing or pulling an element to be actuated.

Another object of the present invention is to provide an affordable, high efficient fan which will require minimal installation space, shipping volume and maintenance.

### BRIEF DESCRIPTION OF THE DRAWINGS

For a fuller understanding of the innovatory principles, objects, features, aspects, and advantages of the present invention with respect to the prior art, reference should be made to the following detailed description of the preferred embodiments thereof, which is to be taken in connection with the accompanying drawings which are given by a way of example, and thus are not limitative of the present invention and wherein,

FIG. 1 shows a front elevation of the fan with the shutter in closed horizontal position.

FIG. 2 is a side elevation view partially in section of the fan along line 1-1 of FIG. 1, with the shutter disposed horizontally and with vanes in open position.

FIG. 3 is an enlarged detail section view along the line 2-2 of FIG. 2.

FIG. 4 is a front view of the centrifugal mechanism.

FIG. 5 is a side elevation view, partially in section, of the centrifugal mechanism with the shutter in closed position.

FIG. 6 is a side elevation view looking inside the centrifugal shutter mechanism, with half of the closed housing removed for clarity, showing the shutter in an open opposition.

FIG. 7 is a front elevation of the propeller assembly with 4 blades, pivotally received in the pulley hub, with the slidably mounted shoes for adjusting tip blade clearance.

Similar reference numerals refer to similar parts throughout views of the drawings.

### DETAILED SCRIPTION OF THE PREFERRED EMBODIMENT

The description which follows is to be understood as being teaching disclosure directed to persons of skill in the appropriate art and not limiting upon the present invention of the accompanying drawings which are given by the way of illustration of the most practical embodiments of the present invention. For a better understanding of the invention, reference shall be made to the accompanying drawings.

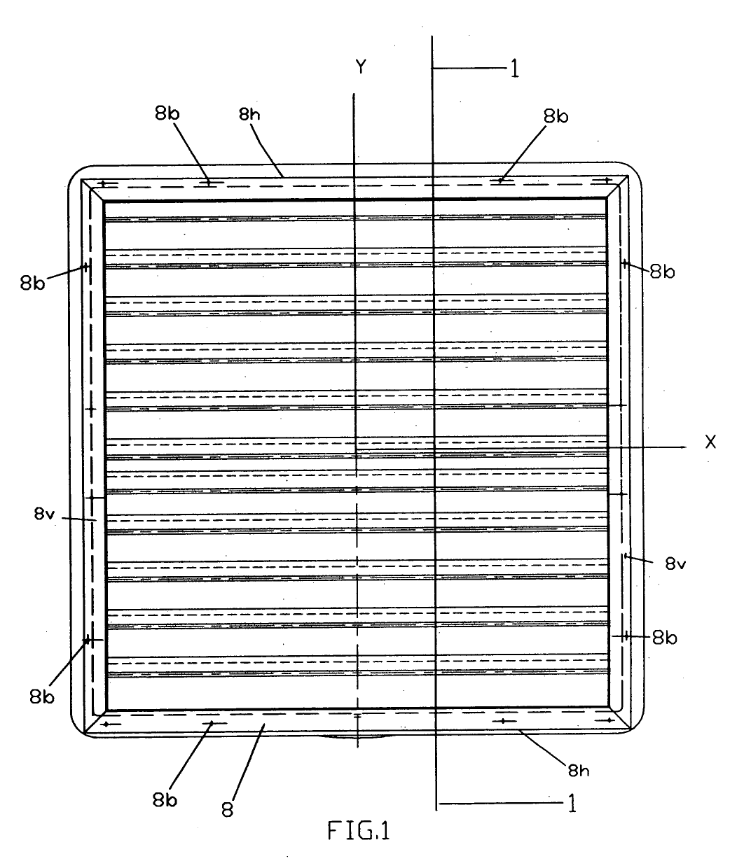

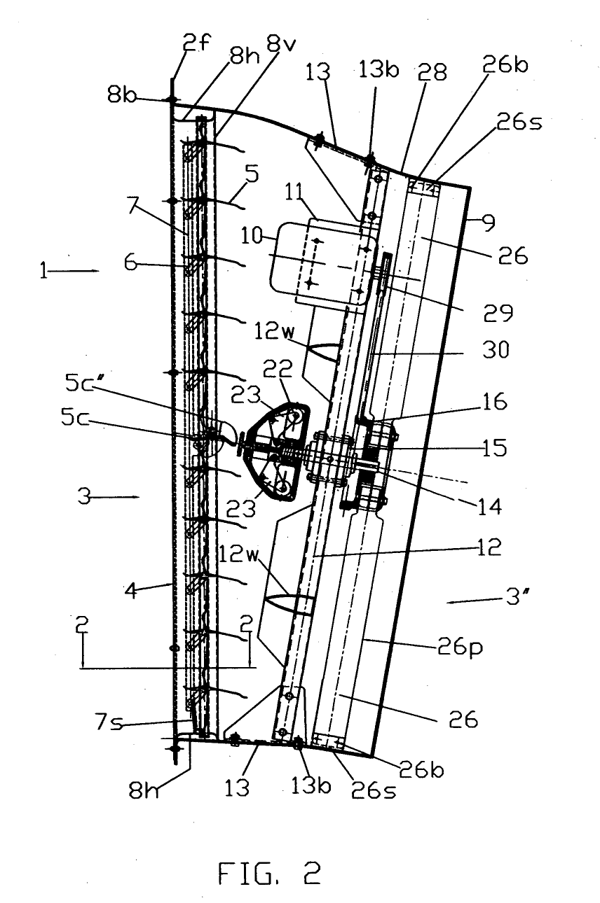

Referring now to the drawings, on FIGS. 1, 2, the Applicant shows an axial belt driven fan, generally indicated by the reference numeral 1 as a whole. The components of said fan 1 include a compact streamlined housing enclosure 2 having an inner cavity defining an air flow passageway with large radii corners, adapted to be installed into a wall opening of a building at a downwardly slanted angle thereto, so that air flow, drainage and laden dusty air can easily transit therethrough.

Said compact fan housing is aerodynamically shaped to provide for high airflow and low noise and it is preferably molded in one piece of plastic formed with the method of rotational molding or is made of fiberglass with the method of resin transfer molding process technology or by sheet metal.

The rotational-mold housings has the advantage to be cost effective however, it has the disadvantage of comporting an undesirable large degree of movements of the plastic, due to temperature variations, therefore this method cannot be used for large size fans unless it is fitted a precise roll-formed rigid steel ring in the inner part of the fan housing adjacent the propeller tip blades.

The housing enclosure 2 comprises a first opening 3 of square cross section comprising a mounting flange 2f, for securing the housing enclosure 2 to the wall opening of said building and securing a self-opening shutter assembly 4, consisting of a square frame assembly 8 comprising a pair of vertical jambs 8v and a pair of rails 8h, an inlet bell mouth 8i, a plurality of individual shutter vanes 5 comprising a central operative vane 5c pivotally received into plastic bearings 8p mounted into longitudinal cavity of the extruded frame assembly 8. Said vanes can be selectively mounted either horizontally, as shown on the above drawings FIG. 1 and FIG. 2, with its longitudinal axis parallel to the horizontal top and bottom sides of the inlet square opening 3 or vertically with its longitudinal axis perpendicular to the horizontal side of said inlet opening (3) of said fan housing (2).

As seen in FIG. 1 and FIG. 2, the Applicant shows an horizontally mounted shutter assembly 4 comprising the plurality of vanes 5 and the central operative vane 5c extending horizontally and pivotally mounted into the opposite jambs 8J of said frame assembly 8. Said vanes 5 and 5c are pivotally connected to each other with cranks 6 and at least one tie rod 7 which extends along at least one side of said vanes 5 and 5c and interconnects adjacent vanes to each other for unison closing or opening of them. Through this arrangement, movements of the tie rod 7 in the direction of its length will cause said vanes 5 and 5c to pivot in unison about their longitudinal axes, to close or to open said shutter assembly 4.

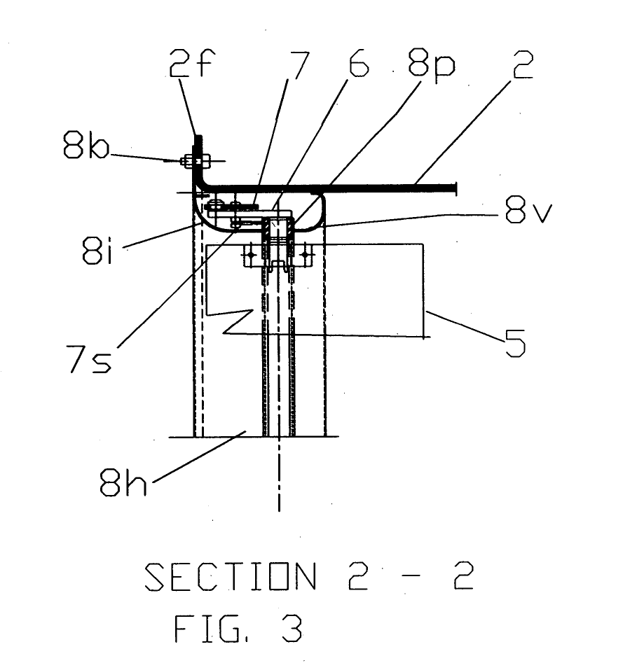

The frame assembly 8 is mounted into the fan housing inlet and as shown in FIG. 3 and forms with the inner surfaces of said housing enclosure 2 an enclosed perimeter on which are enclosed for protection the vital elements of the shutter assembly 4, in particular the spring 7s which is positioned between the shutter frame assembly 8 and the tie rod 7, for causing the opening of the shutter vanes 5 and 5c, upon fan operation. The frame assembly 8 is secured to housing flange 2f with bolts 8b.

On the opposite side of said shutter 4, said housing enclosure 2 comprises a second opening 3″ of a substantially round section including a guard 9 or screen for protecting people outside the building and for preventing anyone to reach the rotating parts of the fan.

A noticeable advantage of this housing disposition is that it allows a full protection from the elements of the electric motor 10 and the mechanical and electrical components of said axial fan. Further advantage is that the dust will not collect within said housing and even if there is some dust accumulation on the bottom part of the housing, said dust can easily be washed away. Moreover, the air flow is more efficient because the vanes are mounted at the fan intake where the air velocity is relatively lower and the flow is more laminar in respect to shutters mounted at the outlet where the air velocity is higher and the air flow is more turbulent.

In the fan of this invention, the air sucked by the propeller is directed from the inlet opening of said fan housing enclosure to the propeller with a minimum of restrictions and turbulence. The Applicant provides an inlet bell mouth, a shutter assembly with few large blades, for smoothly guiding the laden air from the inlet bell mouth toward said Venturi with reduced turbulence. In the contrary the shutters of the prior art have too many short blades. Fewer blades positively closed translate in substantial air tight shutter.

The shutter vanes are designed with overlaps with labyrinth means for perfect closing for preventing back draft and thermal convection losses.

Moreover the operative spring 25 of the axial slidably actuator of the centrifugal mechanism 17 is able to urge together the mating surfaces of said adjacent vanes and apply a positive force tending to move the shutter blades toward the inlet opening with the shutter blades in closed position, to prevent convection heat losses from said shutter assembly.

When the fan is off, all the vanes 5 and 5c are in a closed position with its faces parallel to the inlet face 3 of the fan housing 2 and when the fan is operating said vanes 5 and 5c rotate to an angle substantially aligned with the fan longitudinal axis, thus substantially aligned with the air flow produced by the propeller of said fan.

Referring to FIG. 1 the improved shutter assembly is symmetrical built in rapport to the axis X, Y and it has substantially square cross section therefore, is suitable to be installed to work horizontally or vertically by rotating said shutter assembly of 90 degree.

The dust particles present in the air, by inertia, quickly transit from the inlet opening 3 toward the outlet opening 3″ without dust settling, especially if the shutters are mounted vertically. In a vertical mounted shutter dust particles fall mainly on the bottom area of said fan housing from where it can be easily washed out of the building.

The improved axial fan unit made in accordance with the present invention has the advantage to solve the problems caused by dust accumulation on the conventional shutter of the prior art, the vertical shutters have an automatic cleaning effect and dust cannot accumulate on them.

Contrary to the conventional axial fans with gravity shutters, on the fan of the present invention any air pressure is required to keep the shutters in their open position. Loss of air delivery caused by air pressure needed to hold the gravity shutters open is eliminated, giving the fan of the present invention maximum exhaust air flow.

With reference with FIG. 2, the housing enclosure 2 comprises an electric or hydraulic drive motor 10 suitable for speed regulation, slidably mounted on a rigid base member 11, secured to a streamlined central structural member 12 or support of the fan comprising airfoil shaped wings 12w, for guiding efficiently the air so that turbulence in the air flow stream is minimized and more laminar flow is achieved. Said central structural member 12 mounted within the housing 2 is axially spaced from said openings of said housing and connects opposite sides of said fan housing 2 by means of a pair of L shaped streamlined brackets 13 bolted at each end to the fan housing 2 with bolts 13b.

For large fans it is preferable to brace said central structural member with horizontal arms equipped with airfoil wings.

The streamlined single central structural member 12 is made of a square aluminium tube and extends substantially perpendicular to the shaft 14 which is supported by a pair of rigid pillow blocks bearings 15 bolted to said central structural member 12, said shaft 14 passing through said structural member substantially in the middle thereof, coaxially with the fan axis

This arrangement of said single central structural member and airfoil wings minimizes obstruction of air flow through the housing enclosure and minimizes turbulence in the air for maximum efficiency of the fan.

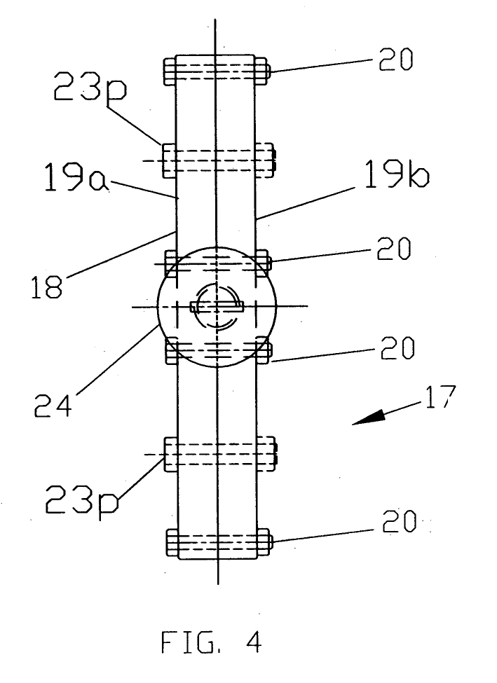

As can be clearly seen in FIGS. 2, 4, 5, 6 a versatile centrifugal mechanism, generally indicated 17 as a whole, is mounted onto one end of the fan drive shaft 14 adjacent to the central vane 5c, opposite to the position of the pulley assembly 26p.

The centrifugal mechanism 17 is designed to close the shutter 4, when the fan is shut off and to allow the shutters to open as soon the fan starts to run and reaches the minimum speed of operation of the fan which as aforesaid is of about 250 RPM.

The centrifugal mechanism proposed in the invention includes a hermetic housing 18 secured to one end of the shaft 14, said housing comprising a pair of matching symmetrical molded shells 19a and 19b preferably made of plastic having an internal cavity. Each shell has a pair of radially extending cavities, symmetrical spaced in respect to the fan axis of rotation, and an axial extending cavity located coaxial to the fan axis, the shells are bolted together with bolts 20 and 23p.

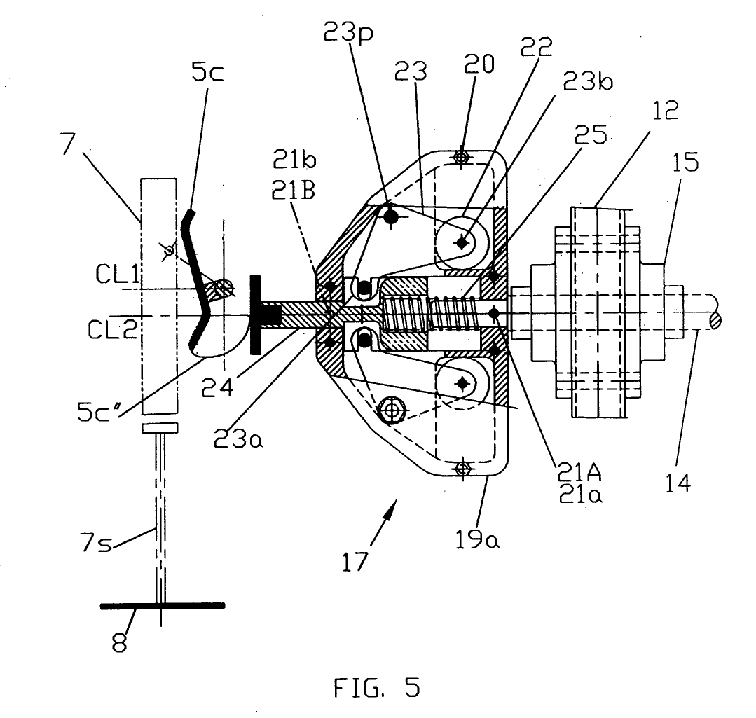

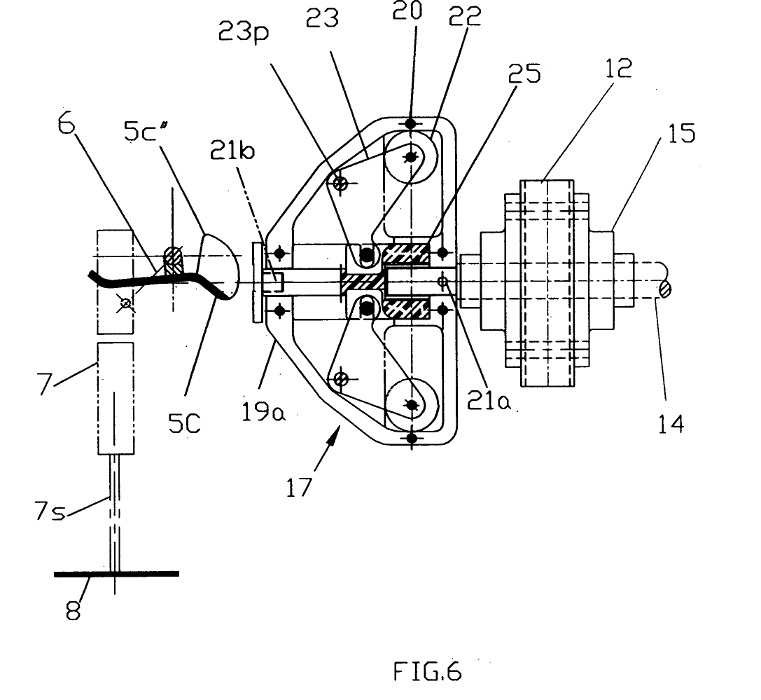

As shown in FIG. 5 and FIG. 6 a first inlet opening 21a and a second outlet opening 21b are provided for securing said enclosed housing to the fan shaft 14, according the function of pulling or pushing an element to be actuated by the centrifugal mechanism.

Said hermetic housing 18 is secured to fan shaft 14 with a springs pin 21A as shown for a mechanism designed for moving away from an element to be actuated or for traction of said element, or can be secured with a spring pin 21B shown in dotted lines, for a similar mechanism (17″) designed for pushing an element to be actuated. In this case the mechanism works in a thrust manner, in this other embodiment it is required a rotatably connection interposed between the axial sliding actuator and the element to be actuated.

In this second other aspect of the invention the centrifugal mechanism (17″) is adapted for pushing an element to be actuate and the housing shall be secured to the fan shaft in the opposite position with respect to that shown in FIG. 5 and FIG. 6 as it will appear clear to those skilled in this art and the slidably axially actuator operative end must be adapted with means for pushing the element to be actuated.

The hermetic housing 18 has been designed such to prevent dust accumulating in the vital part of the apparatus, thereby significantly extending the maintenance period of said centrifugal shutter mechanism, it comprises a pair of radial steel masses 22 mounted within said radial cavities symmetrical spaced in rapport to the fan axis and bolted with bolts 23b to a pair of triangle shaped arms 23 which are pivotally mounted on pivots 20p which are secured to said hermetic housing 18. Each of said triangle shaped swinging arm 23 is provided with an appendix 23a adapted for movably engaging the axial sliding reciprocating actuator 24 which is provided with a slotted opening extending across it for receiving said appendix 23a of each swinging arm 23, therefore said masses 22 will swing equally in unison to move simultaneously the actuator 24 toward the shutter central vane or away from the central operative vane 5c.

The axial sliding reciprocating actuator 24 has a parallelepiped shape, it is made of plastic and is slidably mounted inside said central hollow cavity which is coaxial to the fan axis of rotation and comprises an internal compression spring 25 located within said axial reciprocating actuator 24. Said spring 25 has one end biased to the inside front wall of the axial sliding reciprocating actuator 24 and the other and biased to the inside wall of said hermetic housing 18, as pictured in FIG. 5 and FIG. 6.

The axial sliding reciprocating actuator 24 has a front end comprising a flange 24f adapted to frictionally engage the convex surface of the appendix 5c″ of the central operative vane c5, thus is able to rotate said central vane 5c which has a longitudinal axis CL1 perpendicular to the actuator longitudinal axis CL2. In particular, in order to have a sufficient mechanical vantage and easing the operation of rotation of the central vane c5, said axes are sufficient offset as shown in FIG. 5 and FIG. 6.

Said axial sliding reciprocating actuator 24 can slide inward into said housing 18 for effect of the pulling force of the pair of masses 22 for causing the opening of the shutter and outwardly said housing 18 toward the central vane 5c, for effect of the pushing force of the inner compression spring 25 positively closing the shutter 4, when the fan is not in operation, therefore preventing air, rain or other matter passing through the shutter and for preventing also vibrations, rattling of said shutter vanes.

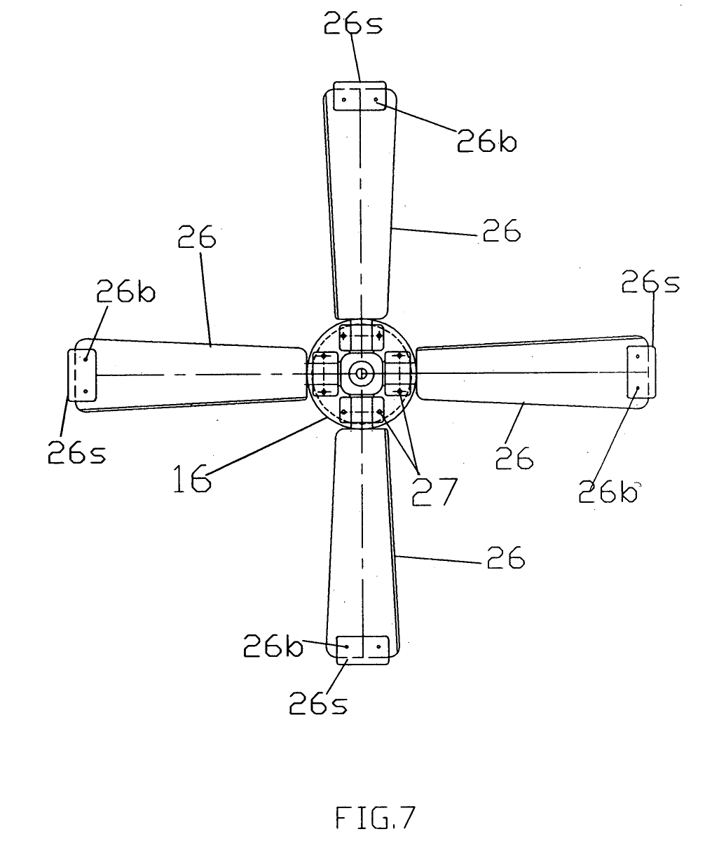

The fan further comprises a propeller-pulley assembly, best shown in FIG. 7, mounted on one end of the shaft 14 comprising a plurality of air foil shaped blades 26 extending radially outwardly therefrom, designed for delivering efficiently and quietly a high volume of air. Each of said blades 26 is pivotally received into the hub of the pulley 16 and secured to it with bolts 27; said pulley 16 is coupled to the motor 10 with belt 30.

The blades 26 are substantially entirely and continuously surrounded at very close distance to the inner part of the said streamlined housing whereon a Venturi 28 is built in for guiding efficiently the air toward the outlet of said fan 1.

Further each blade 26 comprises a radially slidably shoe 26s made of light rubber for adjusting tip clearance between said blades 26 and said Venturi 28. Said sliding adjustable shoes are secured to each tip blade with a pair of bolts 26b.

The Applicant believes that, if in some situation, the versatile shoes come in contact with the Venturi, the light rubber will wear out without noises and will virtually seal off the gap with said Venturi. A small, uniform clearance is preferred to reduce blade tip vortex formation thus, preventing air from flowing back around the propeller tip blades, for increased performance of the fan. Therefore the fan of this invention practically does not need the cumbersome and expensive cones of the prior art, for add-on performance. As a result the fan of the present invention is more compact and less expensive to build and to operate.

The amount of clearance between Venturi and propeller become more critical with increasing static pressure, at zero static pressure the effect of the tip clearance is minimal, but the losses of performance increases quickly with increasing static pressure therefore, the fan of the present invention is suitable to work at relatively higher pressure in rapport to fans of prior art.

The functioning of the centrifugal mechanism 17 may readily be understood by reference of FIGS. 2, 4, 5 and 6.

When the electric or hydraulic motor 10 starts to rotate, its rotation is transmitted from the drive motor pulley 29 to belt 30 and to shaft 14 thus, as the fan speed increases, at the minimum normal speed of operation of about 250 RPM, said masses 22, start to move radially, by centrifugal effect of the masses 22, causing the arms 23 to rotate around the pivot 23p, pushing in the meantime the axial sliding actuator inward said closed housing 18, against the urge of the compression spring 25. Therefore, the axial sliding reciprocating actuator 24 moves axially, away from the central vane 5c enabling the shutter vanes to open for effect of the thrust of the extension operative spring 7s, which applies a force to the tie rod 7 and a torque to the shutter vanes 5 and 5c urging them to rotate in an open position in a direction, substantially coaxial to the fan axis.

As it can be clearly seen, FIG. 6. shows in detail the centrifugal shutter mechanism in open operative position, showing a substantial gap between the front ends of said axial sliding reciprocation actuator 24 and said central vane. When the fan is operating said shutter is kept positively opened by the thrust of the said extension operative spring 7s therefore when said vanes are in their open positions, there is no tendency of the shutters to close and there is no air pressure required to keep the shutters open therefore, the traditional vibrations, wear and undesirable noises through said shutter 4 are eliminated.

When the electric or hydraulic motor of said fan is shut off, the propeller speed decreases progressively, so that the centrifugal forces of said masses 22 decreases, consequently said compression spring 25 pushes the axial sliding actuator 24 forwardly in direction and against said vane 5c, in the first moment, said axial sliding actuator front end closes said existing gap, then enters in contact with said convex shaped element 5c″ of said central vane 5c causing its rotation around its longitudinal axis and simultaneously urging the tie rod 7 to rotate the other shutter vanes 5 in their closed position whereby, the shutters 5 and 5c are positively closed.

The centrifugal mechanism of this invention is suitable, with few changes of the axial sliding actuator, to work for pushing or pulling directly the central vane via a rotatably connection between the axially sliding actuator and the shutter central operative vane. Large fans operate at low speed and have very heavy shutters, therefore it is convenient to rotatably connect the central vane of said shutter and push it with the axially sliding actuator using the significant radial forces of the centrifugal masses for open the heavy shutter.

The centrifugal device of the present invention is a simple and cost effective and allows a gradual and quiet automatic opening and closing of said vertical or horizontal mounted shutter.

Another major vantage of the present invention is that the improved fan housing can be made of plastic with the roto-mold technology, moreover it is designed to nest, therefore we can stack said housings each to another and many units can be shipped or stored for significantly reducing shipping cost and space.

In the drawings and specifications, there has been set forth a preferred embodiment of the invention and, although specific terms are employed, they are used in a generic and descriptive sense only and not for purpose of limitation; thus, it will be appreciated by those skilled in the art that many modifications are possible, some of which have already been mentioned, while other variations can be made thereto without departing from the spirit and scope of the invention. It will thus be seen that the object set forth above and those made apparent from the foregoing description are fully effectively attained.

In the today's energy conscious world, it has become desirable to increase the efficiency of the air moving devices as much as possible. One way to accomplish this is to provide a high quality fan with the unique features of the fan of the present invention.

The embodiment of the invention in which an exclusive property or privilege is claimed are defined as follows:

1. an improved axial fan for exhausting humid, corrosive and dusty air, the improvements comprising:
a) a streamlined housing enclosure having an inner cavity defining an air flow passageway having large radii corners and having a first opening of square section with a shutter assembly consisting of a frame on which are pivotally mounted a plurality of vanes including a central vane, for closing or opening said first opening, each of said vanes being pivotally interconnected, with crank rods and at least one tie rod, said frame further comprising an operative extension spring with one end connected to said frame and the other end connected to said tie rod for urging, upon fan operation, the shutter vanes toward full wide open position,
b) an axially spaced second opening of round section including a safety guard,
c) a streamlined central structural member, axially spaced between said openings, connecting two opposite sides of said housing and comprising a pair of airfoil wings for guiding efficiently the air flow,
d) a drive motor either electric or hydraulic mounted on a rigid base secured to said central structural member,
e) a propeller-pulley assembly secured at one end of a rotating shaft fitted into a pair of pillow blocks bearings bolted to said central structural member in the middle thereof for rotatably holding said propeller-pulley assembly comprising a plurality of airfoil blades extending radially outwardly therefrom and rotating therewith, said propeller pulley assembly being located opposite to said shutter assembly,
f) a Venturi built with said streamlined fan housing enclosure, substantially entirely surrounding at close distance the tip blades of the propeller,
g) a centrifugal shutter mechanism, connected at one end of said rotating shaft of said fan, comprising means for moving the shutter from a closed position, when the fan is disabled, to a normally open position when the fan is enabled, and comprising an hermetic housing assembly for preventing dust accumulating in the vital parts of said mechanism, said housing being made up of a pair of matching molded shells comprising a pair of oppositely radially extending cavities, each cavity including a pair of movable masses equally spaced apart relative to the fan rotational axis and operatively connected to an axially sliding reciprocating actuator via a pair of arms pivotally attached to said hermetic housing, said arms being operatively connected at corresponding ends respectively to the axially sliding actuator located into an axially extending cavity of said hermetic housing coaxially to said fan axis of rotation and positioned adjacent to said central operative vane of said shutter assembly, said axial sliding actuator further comprising an internal operative spring and an operative end located at proximity of the shutter central vane, said actuator being movable between an outwardly position frictionally engaging a convex shaped cam secured to said central vane of said shutter to rotate and shut said shutter central vane and the other vanes by the biasing force of said internal spring and an inwardly position away from said central vane of said shutter for causing the opening of said shutter in response to the rotation of said propeller, said opening and closing controlled by the minimum speed of operation of the said fan.

2. The fan as claimed in claim 1, wherein said plurality of radial airfoil blades comprise radial extending adjustable flexible means mounted at the tips of each blade for adjusting the tip blade clearance with said Venturi of said fan housing, said improved housing including a novel rigid roll formed ring located adjacent to said tip blades.

3. The fan as claimed in claim 2, wherein said adjustable flexible means are made of soft rubber adapted to minimize the clearance between Venturi and tip blades for preventing air from flowing back around the tip blades for increased performance of said fan, enabling it to work efficiently at higher static pressure with reduced air vortices, vibrations and noise.

4. A shutter assembly to close or to open the inlet opening or the outlet opening of a fan, wherein said shutter comprises a frame structure with a plurality of vanes including a central vane pivotally mounted thereon, said vanes extending vertically for preventing dust accumulation, being parallel with one another, pivotal about a vertical axis defined by aligned projecting pins that extend into corresponding openings on top and bottom framing portions of the shutter frame of said fan, said vanes being pivotally interconnected with crank rods and at least a tie rod and comprising means to be operated by a centrifugal shutter mechanism secured to said fan for rotation positioned in proximity of said shutter central vane, for causing said shutter central operative vane and the other vanes to pivot about their vertical axes, to open the shutter upon fan rotation and to close said shutter when the fan is not operating.

5. The fan as claimed in claim 4, wherein said shutter assembly comprises spring means positioned between said shutter frames and said tie rod for causing the opening of the shutter and for biasing said shutters to a open position with shutter faces aligned to the air flow.

6. The fan as claimed in claim 1, wherein said square frame of said shutter assembly is made of extruded aluminium or plastic elements including longitudinally extending cavities comprising plastic rods on which are pivotally received said vanes of said shutter, said frame assembly being adapted to be mounted selectively either horizontally or vertically across said inlet opening of said fan housing wherein, said frame forming a perimeter labyrinth for protecting from dust the mechanisms of the shutter assembly.

7. The fan as claimed in claim 1, wherein said centrifugal shutter mechanism, in a second embodiment, comprises means for rotatably connecting the shutter central vane of said shutter assembly for pushing or pulling said central operative vane from a first position wherein said vanes closes off the air passage through the inlet opening of the fan housing to a second position wherein air is permitted to flow through the inlet opening of said fan housing.

8. The fan as claimed in claim 1, wherein said centrifugal shutter mechanism comprises an hermetic housing comprising at least a pair of triangle shaped arms comprising a pair of centrifugal masses secured thereto, pivotally mounted into said enclosed housing equally spaced in rapport to the fan axis of rotation, each of said arms being movable connected at corresponding ends with said axial sliding actuator for transferring radial movements of said radial centrifugal masses, upon fan rotation, to axially movements of said axial actuator. So that said masses and said arms will swing in unison during any axial stroke of the axially sliding actuator.

9. The fan as claimed in claim 1, wherein said vanes of said shutter assembly comprise mating surfaces with labyrinth type means cooperating with the axial sliding actuator with means adapted to provide a positive seal force against said mating surfaces of said vanes, so that leakage is substantially uninhibited, when the shutters are closed to thereby provide an air tight barrier against air movements through the shutter, preventing convection heat losses through the shutter.

10. A centrifugal shutter mechanism associated with a fan shutter, said mechanism comprising means for causing the opening of the shutters and means for closing positively the shutters, wherein said means comprise an axially sliding actuator disposed adjacent to the shutter, said shutter comprising a plurality of self opening vanes comprising a central operative vane pivotally mounted in a rigid frame structure, each vane being pivotal about a vertical longitudinal axis for having an automatic cleaning effect for preventing dust accumulation thereto, for the correct functioning of said shutters.
